(19) United States
(12) Patent Application Publication
(10) Pub. No.: US 2026/0002813 A1
(43) Pub. Date: Jan. 1, 2026

(54) CLASSIFYING APPARATUS, CLASSIFYING METHOD, AND NON-TRANSITORY COMPUTER-READABLE STORAGE MEDIUM

(71) Applicant: NEC Corporation, Minato-ku, Tokyo (JP)

(72) Inventors: Hemant Shivsagar PRASAD, Tokyo (JP); Takashi MATSUSHITA, Tokyo (JP); Daisuke IKEFUJI, Tokyo (JP); Murtuza PETLADWALA, Tokyo (JP)

(73) Assignee: NEC Corporation, Minato-ku, Tokyo (JP)

(21) Appl. No.: 18/879,373

(22) PCT Filed: Jul. 22, 2022
(86) PCT No.: PCT/JP2022/028499

§ 371 Date: Dec. 27, 2024

(51) Int. Cl. G01H 1/00; G06F 18/2431

(52) U.S. Cl. CPC G01H 1/00; G06F 18/2431

(57) ABSTRACT

A classifying apparatus performs: acquiring a waterfall data that indicates amplitude of vibration for each point in time and for each sensing point in a vibration sensor that is placed along a target object; performing semantic segmentation on the waterfall data to generate a class data that indicates a normal class or an abnormal class for each element of the waterfall data; and classifying the sensing points into a monitoring point and a non-monitoring point. The normal class is assigned to the element whose sensing point is predicted to be the monitoring point. The abnormal class is assigned to the element whose sensing point is predicted to be the non-monitoring point. The monitoring point is the sensing point that is placed along the target object. The non-monitoring point is the sensing point that is not placed along the target object.

### TECHNICAL FIELD

The present disclosure generally relates to a classifying apparatus, a classifying method, and a non-transitory computer-readable storage medium.

### BACKGROUND ART

There are techniques to use a vibration sensor to monitor an object, such as a road. PTL1 discloses a technique to use a distributed acoustic sensing (DAS) system as a vibration sensor to obtain a waterfall data that indicates an amplitude of vibration sensed by the vibration sensor for each one of multiple locations and for each one of multiple points in time.

### CITATION LIST

### Patent Literature

PTL1: Japanese Unexamined Patent Application Publication No.2021-121917

### SUMMARY OF INVENTION

### Technical Problem

PTL1 does not teach a case where some points of the vibration sensor are not placed along the object to be monitored. An objective of this disclosure is to provide a novel technique to handle data obtained from a vibration sensor that is installed to monitor an object.

### Solution to Problem

The present disclosure provides a classifying apparatus comprising at least one memory that is configured to store instructions and at least one processor.

The at least one processor is configured to execute the instructions to: acquire a waterfall data that indicates amplitude of vibration for each point in time and for each sensing point in a vibration sensor that is placed along a target object; perform semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and classify the sensing points into the monitoring point and the non-monitoring point based on the class data.

The present disclosure further provides a classifying method performed by a computer.

The classifying method comprises: acquiring a waterfall data that indicates amplitude of vibration for each point in time and for each sensing point in a vibration sensor that is placed along a target object; performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and classifying the sensing points into the monitoring point and the non-monitoring point based on the class data.

The present disclosure further provides a non-transitory computer readable storage medium storing a program.

The program causes a compute to execute: acquiring a waterfall data that indicates amplitude of vibration for each point in time and for each sensing point in a vibration sensor that is placed along a target object; performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and classifying the sensing points into the monitoring point and the non-monitoring point based on the class data.

### Advantageous Effects of Invention

According to the present disclosure, a novel technique to handle data obtained from a vibration sensor that is installed to monitor an object is provided.

### BRIEF DESCRIPTION OF DRAWINGS

FIG. 1 illustrates an overview of a classifying apparatus of the first example embodiment.

FIG. 2 is a block diagram illustrating an example of a functional configuration of the classifying apparatus of the first example embodiment.

FIG. 3 is a block diagram illustrating an example of a hardware configuration of the classifying apparatus of the first example embodiment.

FIG. 4 is a flowchart illustrating an example flow of processes performed by the classifying apparatus of the first example embodiment.

FIG. 5 illustrates a way to generate the monitoring data based on the waterfall data.

FIG. 6 is a flowchart illustrating an example flow of processes performed by the classifying apparatus that uses the sensing point information in the future processes.

FIG. 7 illustrates an overview of the classifying apparatus of the second example embodiment.

FIG. 8 illustrates the object trajectory detected from the waterfall data.

FIG. 9 illustrates the object trajectory in a case where the sensing points are not correctly classified.

FIG. 10 illustrates the object trajectory in a case where the sensing points are correctly classified.

FIG. 11 is a block diagram illustrating an example of the functional configuration of the classifying apparatus of the second example embodiment.

FIG. 12 is a flowchart illustrating an example flow of processes performed by the classifying apparatus of the second example embodiment.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### Example Embodiment 1

### Overview

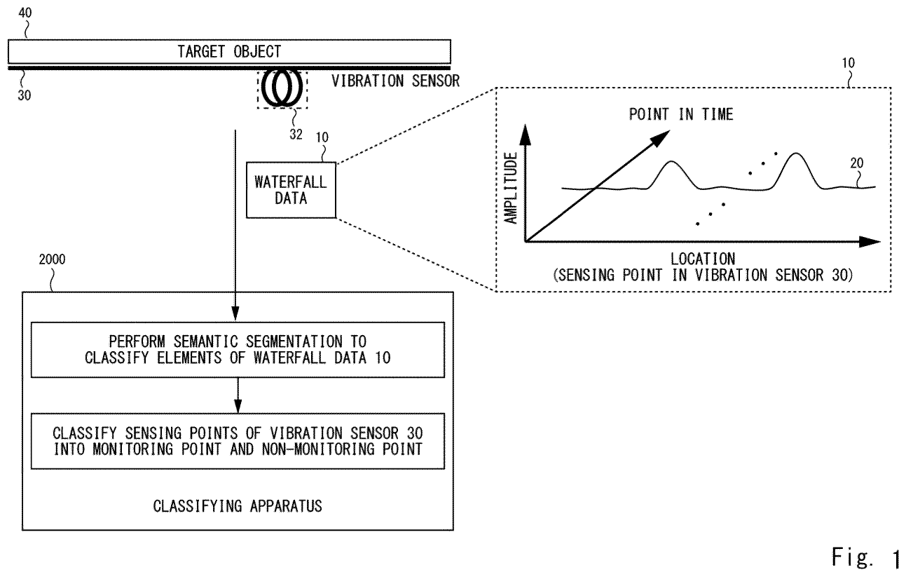

FIG. 1 illustrates an overview of a classifying apparatus 2000 of the first example embodiment. It is noted that the overview illustrated by FIG. 1 shows an example of operations of the classifying apparatus 2000 to make it easy to understand the classifying apparatus 2000, and does not limit or narrow the scope of possible operations of the classifying apparatus 2000.

The classifying apparatus 2000 is configured to handle a waterfall data 10 that indicates an amplitude of vibration sensed by a vibration sensor 30 for each one of two or more points in the vibration sensor 30 and for each one of two or more points in time. In some embodiments, the waterfall data 10 may be a time series of two or more sensing data 20. The sensing data 20 is generated by the vibration sensor 30, and indicates an amplitude of vibration sensed at each one of two or more points of the vibration sensor 30 at a point in time.

The vibration sensor 30 is installed (placed) along an object to be monitored, such as a road. Hereinafter, the object to be monitored by the vibration sensor 30 is called “target object 40”.

An example of the vibration sensor 30 is a DAS system that includes a DAS device and an optical fiber cable. In the case where the DAS system is employed as the vibration sensor 30, the optical fiber cable is placed along the target object 40 and is attached to the DAS device. The DAS device is configured to transmit a laser pulse through the optical fiber cable and to receive the reflection of the transmitted laser pulse.

Since vibration occurred at a certain point of the target object 40 affects the laser pulse that is traveling at that point of the target object 40 at that time, the DAS device can measure an amplitude of the vibration occurred at that point of the target object 40 by analyzing the reflection of the transmitted laser pulse. Thus, the DAS device can generate the sensing data 20 that indicates the amplitude of vibration that is sensed at each one of two or more points of the optical fiber cable. Hereinafter, a point of the vibration sensor 30 (e.g., the optical fiber cable) at which the amplitude of vibration is sensed is called “sensing point”.

In some implementations, the waterfall data 10 may be formed as a matrix data denoted by W. The row of the matrix data W may represent point in time whereas the column thereof represents sensing point of the vibration sensor 30. In this case, an element at the i-th row and the j-th column of the waterfall data 10 (i.e., W[i][j]) represents the amplitude of vibration sensed at the j-th sensing point of the vibration sensor 30 at the i-th point in time.

In addition, the sequence of the elements in the i-th row of the waterfall data 10 (i.e., {W[i][0], W[i][1], . . . , W[i][M]} where M represents the total number of the sensing points indicated by the waterfall data 10) represents the sensing data 20 that is generated at the i-th point in time. On the other hand, the sequence of the elements in the j-th column of the waterfall data 10 (i.e., {W[0][j], W[1][j], . . . , W[N][j]} where N represents the total number of the points in time indicated by the waterfall data 10) represents a time series of the amplitudes of vibration that are sensed at the j-th sensing point.

The waterfall data 10 formed as a matrix data may be handled as an image data, called “waterfall image” hereinafter. In this case, W[i][j] corresponds to a value of the pixel (i,j) of the waterfall image. Suppose that the amplitudes of vibration sensed by the vibration sensor 30 are quantized and normalized to a rage of 0 to 255. In this case, the waterfall data 10 can be formed as a grayscale image. It is noted, however, that the waterfall data 10 is not necessarily handled as an image data.

The vibration sensor 30 may include one or more sensing points that are not placed along the target object 40 (in other words, not suitably located to monitor the vibration of the target object 40). For example, the vibration sensor 30 may have some extra segment 32 as depicted by FIG. 1. The amplitude of vibration sensed at the sensing points in those extra segments 32 do not accurately indicate the amplitude of vibration of the target object 40. Hereinafter, the sensing point that is placed along the target object 40 is called “monitoring point”, whereas the sensing point that is not placed along the target object 40 (e.g., the sensing point included in the extra segment 32) is called “non-monitoring point”.

Taking the existence of the non-monitoring points into consideration, the classifying apparatus 2000 is configured to use the waterfall data 10 to detect monitoring points of the vibration sensor 30. Specifically, the classifying apparatus 2000 acquires the waterfall data 10, and performs semantic segmentation on the waterfall data 10. Semantic segmentation is a technique to analyze a collection of two or more data to classify them into two or more classes. Through the semantic segmentation, one of two or more classes (types, in other words) is assigned to each element of the waterfall data 10.

The class may include NORMAL and ABNORMAL. NORMAL is assigned to the element of the waterfall data 10 that is predicted to indicate the amplitude of vibration that is sensed at a monitoring point of the vibration sensor 30. On the other hand, ABNORMAL is assigned to the element of the waterfall data 10 that is predicted to indicate the amplitude of vibration that is sensed at a non-monitoring point of the vibration sensor 30.

As a result of the semantic segmentation on the waterfall data 10, the classifying apparatus 2000 generates a class data that indicates the class for each element of the waterfall data 10. The class data may be formed in a manner similar to the waterfall data 10. Suppose that the waterfall data 10 is formed as a N×M matrix denoted by W. In this case, the class data may be formed as a N×M matrix denoted by C wherein C[i][j] indicates the class assigned to W[i][j].

Based on the class data, the classifying apparatus 2000 determines which sensing points are the monitoring points; in other words, the classifying apparatus 2000 classifies the sensing points into the monitoring point and the non-monitoring point based on the class data. When the waterfall data 10 is a matrix data whose column represents sensing point, it can be rephrased that the classifying apparatus 2000 determines which columns of the waterfall data 10 show amplitudes of vibrations sensed at the monitoring points based on the class data; in other words, the classifying apparatus 2000 classifies the columns of the waterfall data 10 into the column corresponding to the monitoring points and the column corresponding to the non-monitoring point based on the class data. Some other examples of classifying apparatus which determines monitoring and non-monitoring points or portions of monitoring and non-monitoring points could be analytical techniques based on statistical measures of the waterfall data.

### Example of Advantageous Effect

According to the classifying apparatus 2000 of the first example embodiment, the elements of the waterfall data 10 are classified into the normal class and the abnormal class through semantic segmentation, and the sensing points of the vibration sensor 30 are classified into the monitoring point and the non-monitoring point based on the result of the classification of the elements of the waterfall data 10. This is a novel way of handling the waterfall data 10, which is acquired from a vibration sensor that monitors an object.

As explained in detail later, the classification of the sensing points into the monitoring point and the non-monitoring point is useful in various manners. For example, the classifying apparatus 2000 can remove the influence of the non-monitoring points, with which the amplitude of vibrations of the target object 40 cannot be measured accurately, from the waterfall data 10 by removing the regions of the non-monitoring points from the waterfall data 10.

Hereinafter, more detailed explanation of the classifying apparatus 2000 will be described.

### Example of Functional Configuration

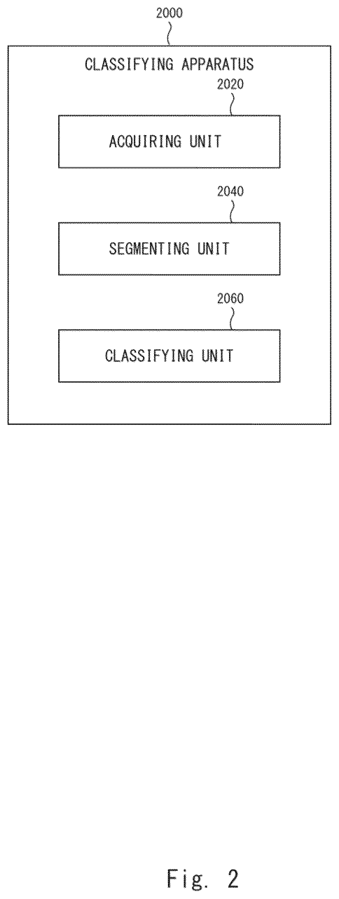

FIG. 2 is a block diagram illustrating an example of the functional configuration of the classifying apparatus 2000 of the first example embodiment. The classifying apparatus 2000 includes an acquiring unit 2020, an segmenting unit 2040, and classifying unit 2060. The acquiring unit 2020 acquires the waterfall data 10. The segmenting unit 2040 performs semantic segmentation on the waterfall data 10 to generate the class data that indicates one of two or more classes for each element of the waterfall data 10. The classifying unit 2060 classifies the sensing points of the vibration sensor 30 into the monitoring point and the non-monitoring point based on class data.

### Example of Hardware Configuration

The classifying apparatus 2000 may be realized by one or more computers. Each of the one or more computers may be a special-purpose computer manufactured for implementing the classifying apparatus 2000, or may be a general-purpose computer like a personal computer (PC), a server machine, or a mobile device.

The classifying apparatus 2000 may be realized by installing an application in the computer. The application is implemented with a program that causes the computer to function as the classifying apparatus 2000. In other words, the program is an implementation of the functional units of the classifying apparatus 2000 that are exemplified by FIG. 2.

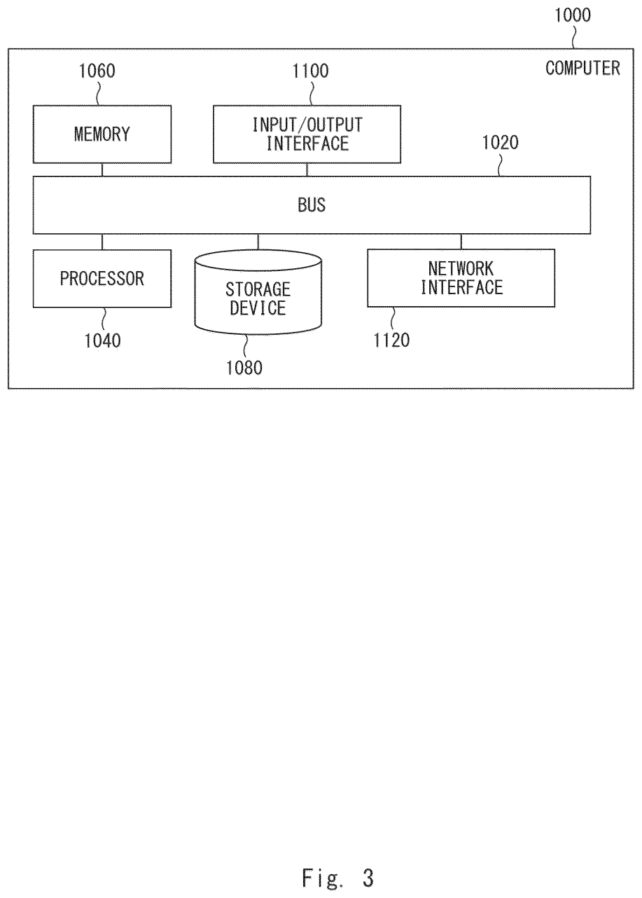

FIG. 3 is a block diagram illustrating an example of the hardware configuration of a computer 1000 realizing the classifying apparatus 2000 of the first example embodiment. In FIG. 3, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The hardware configuration of the computer 1000 is not restricted to that shown in FIG. 3. For example, as mentioned-above, the classifying apparatus 2000 may be realized as a combination of multiple computers. In this case, those computers may be connected with each other through the network.

### Flow of Process

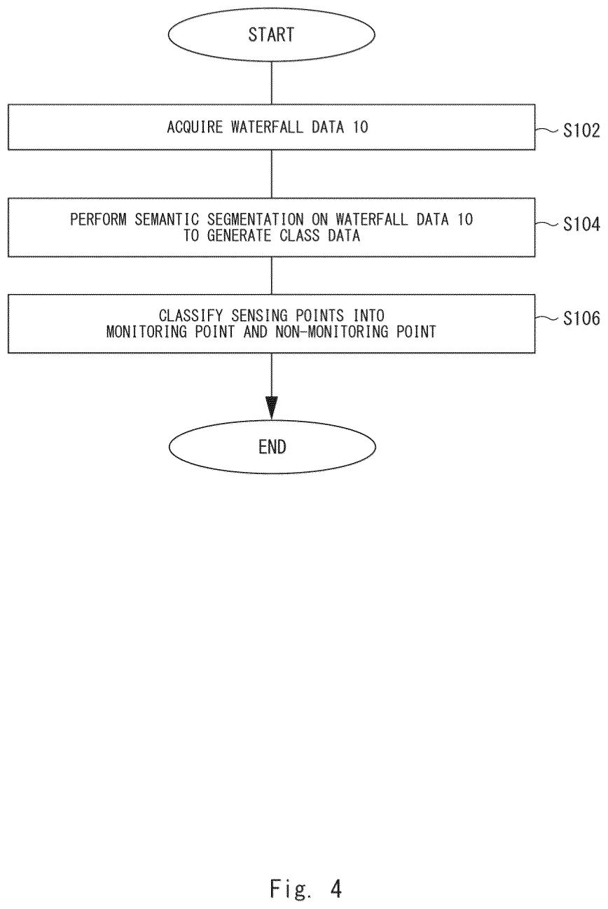

FIG. 4 is a flowchart illustrating an example flow of processes performed by the classifying apparatus 2000 of the first example embodiment. The acquiring unit 2020 acquires the waterfall data 10 (S102). The segmenting unit 2040 performs semantic segmentation on the waterfall data 10 to generate the class data (S104). The classifying unit 2060 classifies the sensing points into the monitoring point and the non-monitoring point (S106).

Acquisition of Waterfall data 10: S102

The acquiring unit 2020 acquires the waterfall data 10 (S102). As mentioned above, the waterfall data 10 represents a time series of the sensing data 20. In some embodiments, the acquiring unit 2020 may acquire two or more sensing data 20 of different points in time from each other, thereby acquiring a time series of those sensing data 20 as the waterfall data 10. In other words, the acquiring unit 2020 converting the acquired two or more sensing data 20 into the waterfall data 10.

There are various ways to acquire the sensing data 20. In some embodiments, the vibration sensor 30 puts the sensing data 20 into a storage device to which the classifying apparatus 2000 has access. In this case, the acquiring unit 2020 may access to this storage device to acquire the sensing data 20. In other embodiments, the vibration sensor 30 sends the sensing data 20 to the classifying apparatus 2000. In this case, the acquiring unit 2020 may receive the sensing data 20 sent by the vibration sensor 30, thereby acquiring the sensing data 20. It is noted that the acquiring unit 2020 may acquire two or more sensing data 20 one by one or simultaneously.

The conversion of two or more sensing data 20 into the waterfall data 10 may be performed by another computer in advance. In this case, the acquiring unit 2020 may acquire the waterfall data 10 at once.

### Semantic Segmentation: S104

The segmenting unit 2040 performs semantic segmentation on the waterfall data 10 (S104). As mentioned above, the classifying apparatus 2000 may handle two classes, called NORMAL and ABNORMAL. In this case, one of these two classes is assigned to each element of the waterfall data 10 as a result of the semantic segmentation.

There are various ways to perform semantic segmentation on the waterfall data 10. In some embodiments, a machine learning-based model, called “segmenting model”, is used to perform the semantic segmentation on the waterfall data 10. The segmenting model may be configured to take the waterfall data 10 as input, analyze the waterfall data 10 to determine the class of each element, and output the class data. The analysis of the waterfall data 10 may include: extracting features from the waterfall data 10; and upsampling the extracted features to the same size as the input data to generate the class data.

The segmenting model may be implemented as one of various types of machine learning-based model, such as a neural network. A few examples of neural network suitable for implementing the segmenting model are U-net, region based convolution neural network (R-CNN), Fast R-CNN, and Faster R-CNN.

The segmenting model is trained in advance of an operating phase (testing phase, in other words) of the classifying apparatus 2000. Hereinafter, a computer that performs the training of the segmenting model is called “training apparatus”. The training apparatus may be the classifying apparatus 2000 or may be another apparatus.

To train the segmenting model, the training apparatus uses a training dataset that includes two or more training data. The training data may be formed as a combination of a training input data and a ground-truth data. The training input data represents the waterfall data whereas the ground-truth data represents the class data corresponding to the training input data. Specifically, the ground truth data is the class data each of whose element indicates the class that should be assigned to the corresponding element of the training input data.

It is noted that there are various well-known techniques to train machine learning-based models using the training dataset, and any one of those techniques can be applied to the training apparatus to train the segmenting model. For example, the training apparatus inputs the training input data into the segmenting model and obtain the class data from the segmenting model. Then, the training apparatus updates trainable parameters of the segmenting model (e.g., weights of edges and biases of a neural network) based on a loss that represents a degree of difference between the ground truth data and the class data that is output from the segmenting model. The training apparatus trains the segmenting model by repeatedly updating the segmenting model with multiple training data in the training data set.

It is noted that the size of data that the segmenting model can handle at once may be less than that of the waterfall data 10. In this case, the segmenting unit 2040 divides the waterfall data 10 into two or more partial data, called “patches”, whose sizes are the same as the size of the input of the segmenting model. Then, the segmenting unit 2040 inputs the patches into the segmenting model, thereby obtaining the class data for each patch. The segmenting unit 2040 can obtain the class data of a whole of the waterfall data 10 by concatenating the class data of each patch.

In some embodiments, the segmenting unit 2040 may further take one or more measurement conditions into consideration to perform the semantic segmentation on the waterfall data 10. For example, the measurement condition may include a period of time during which the vibration sensor 30 performs the measurement to generate the waterfall data 10. In another example, the measurement condition may include one or more weather conditions, such as a weather type (e.g., sunny, cloudy, or rainy), a temperature, or a humidity during the measurement is performed by the vibration sensor 30. In another example, the measurement condition may include parameters related to the vibration sensor 30, such as sensitivity of the vibration sensor 30.

When one or more measurement conditions are used for the semantic segmentation, the segmenting model may be configured to further take the one or more measurement conditions as input. In addition, the segmenting model may be further configured to extract features from each one of the waterfall data 10 and the measurement conditions, compute combined features of those extract features, and upsample the combined features to the same size as the input data to generate the class data.

The segmenting model is required to be trained not only with the waterfall data but also with the measurement conditions. Thus, the training input data further includes the measurement conditions as well as the waterfall data so that the training apparatus can trains the segmenting model with the measurement conditions.

In order to use the measurement conditions for the semantic segmentation, the acquiring unit 2020 acquires the measurement conditions. For example, the acquiring unit 2020 may acquire the measurement conditions from a storage device in which the measurement conditions are stored in advance and to which the classifying apparatus 2000 has access. In another example, the measurement conditions may be sent from another computer to the classifying apparatus 2000, and the acquiring unit 2020 may receive those measurement conditions.

### Classification of Sensing Point: S106

The classifying unit 2060 classifies the sensing points into the monitoring point and the non-monitoring point based on the class data (S106). Conceptually, the sensing point is more likely to be the monitoring point as more elements of the waterfall data 10 corresponding to that sensing point are classified into the NORMAL class.

Since the waterfall data 10 includes two or more elements for each sensing point, it is possible that both the NORMAL class and the ABNORMAL class are assigned to the elements of the waterfall data 10 corresponding to the same sensing point as each other. To handle this situation, the classifying unit 2060 may determine, for each sensing point, whether or not the sensing point is the monitoring point based on the number of the elements of the waterfall data 10 corresponding to the sensing point to which the NORMAL class is assigned. Specifically, for each sensing point, the classifying unit 2060 may use the class data to determine the number of the elements of the waterfall data 10 corresponding to the sensing point to which the NORMAL class is assigned, and determines whether the determined number is larger than or equal to a predefined threshold.

When the determined number is larger than or equal to the threshold, the classifying unit 2060 determines that the sensing point is the monitoring point. On the other hand, when the determined number is less than the threshold, the classifying unit 2060 determines that the sensing point is the non-monitoring point.

Suppose that the waterfall data 10 is a N×M matrix data whose column represents the sensing point and whose row represents point in time. In addition, the threshold mentioned above is set to be T. In this case, for each column j (1<=j<=M) of the waterfall data 10, the classifying unit 2060 determines the number of the elements in the column j (denoted by C[j]) to which the NORMAL class is assigned. If C[j]>=T (i.e., the NORMAL class is assigned to T or more elements in the column j), the sensing point corresponding to the column j is determined to be the monitoring point. On the other hand, if C[j]<T (i.e., the NORMAL class is assigned to less than T elements in the column j), the sensing point corresponding to the column j is determined to be the non-monitoring point.

In other embodiments, instead of the number of the elements in the column j of the waterfall data 10 to which the NORMAL class is assigned, the percentage of the elements in the column j of the waterfall data 10 (denoted by P[j]) to which the NORMAL class is assigned may be used to detect the monitoring point. P[j] can be defined as “P[j]=C[j]/N”. In this case, the classifying unit 2060 may compare P [j] with a predetermined threshold for each column j to determine whether the sensing point corresponding to the column j is the monitoring point or the non-monitoring point.

In other embodiment, the classifying unit 2060 may takes the total number of the monitoring points in the vibration sensor 30 into consideration. When the length of the target object 40 is known in advance, it is possible to predict the total number of the monitoring points in the vibration sensor 30, which is denoted by Ns. Suppose that the length of the target object 40 is L[m] and the interval between the monitoring points are defined to be a[m] in advance. In this case, the total number of the monitoring points can be predicted as Ns=L/a.

Taking the total number of the monitoring points into consideration, the classifying unit 2060 may sort the sensing points in the descending order of the likelihood of being the monitoring point, and determine the 1st to (L/a)-th sensing point as the monitoring point. The rest of the sensing points are determined to be the non-monitoring point. The likelihood of the sensing point being the monitoring point may be represented the number of the elements of the waterfall data 10 corresponding to that sensing point to which the NORMAL class is assigned; e.g., represented by C[j] in the case exemplified above.

The classifying unit 2060 may generate information, called “sensing point information”, that indicates the result of the classification of the sensing points. Specifically, the sensing point information may indicate two lists called “monitoring point list” and “non-monitoring point list”. The monitoring point list indicates the identifiers of the sensing points that are classified as the monitoring point. On the other hand, the non-monitoring point list indicates the identifies of the sensing points that are classified as the non-monitoring point.

### Example Usages of Sensing Point Information

The sensing point information may be used in various manners. For example, the classifying apparatus 2000 may use the sensing point information to remove the influence of the non-monitoring points from the waterfall data 10. Specifically, the classifying apparatus 2000 may remove the elements of the waterfall data 10 corresponding to the non-monitoring points, thereby obtaining a time-series data that represents the amplitude of vibration for each monitoring point: in other words, the amplitude of vibration for each point of the target object 40. Hereinafter, this time-series data is called “monitoring data”.

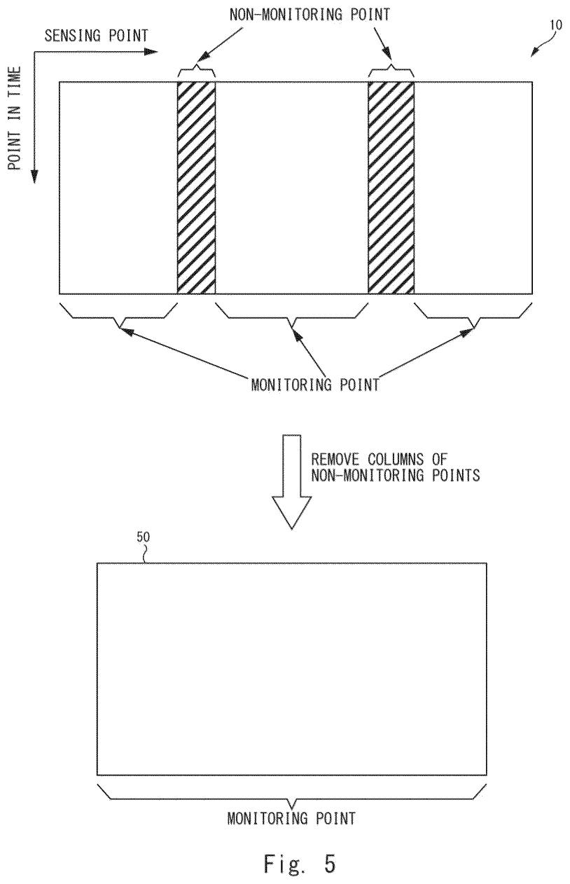

FIG. 5 illustrates a way to generate the monitoring data based on the waterfall data 10. In this example, the waterfall data 10 is a matrix data whose column represents sensing point and whose row represent point in time. The classifying apparatus 2000 performs the steps S102 to S106 to classify the sensing points into the monitoring point and the non-monitoring point. In FIG. 5, the columns of the non-monitoring points are filled with a diagonal stripe pattern.

The classifying apparatus 2000 removes the columns of the non-monitoring points from the waterfall data 10, and concatenates the columns that are not removed into a single matrix data. This matrix data is handled as the monitoring data 50.

The classifying apparatus 2000 can use the sensing point information to localize one or more locations of the target object 40. Specifically, the classifying apparatus 2000 can determine the interval of the monitoring points by dividing the length of the target object 40 by the number of the monitoring points. When the interval of the monitoring points is determined to be I[m], the location of the target object 40 corresponding to the k-th monitoring point can be determined to be at I*k[m] from the start point of the target object 40. By applying the result of the localization to the monitoring data 50, the classifying apparatus 2000 can modify the monitoring data 50 so as to indicate the time series of the amplitude of vibration for each location of the target object 40 that corresponds to the monitoring point.

The sensing point information may be used not only for the current waterfall data 10 but also for the waterfall data 10 obtained in the future. It enables the classifying apparatus 2000 to avoid frequently performing the classification of the sensing points, thereby reducing computer resources used by the classifying apparatus 2000.

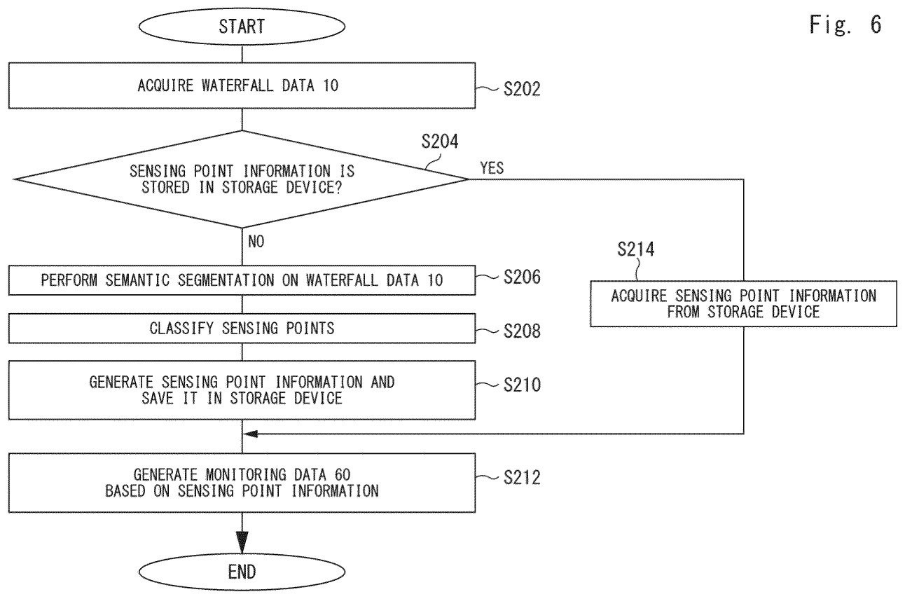

FIG. 6 is a flowchart illustrating an example flow of processes performed by the classifying apparatus 2000 that uses the sensing point information in the future processes.

The classifying apparatus 2000 acquires the waterfall data 10 that is generated by the vibration sensor 30 (S202), and determines whether or not the sensing point information is stored in a storage device (S204).

When it is determined that the sensing point information is not stored in the storage device (S204: NO), the classifying apparatus 2000 performs semantic segmentation on the waterfall data 10 (S206) and classifies the sensing points (S208). Then, the classifying apparatus 2000 generates the sensing point information and saves it in the storage device (S210). Based on the sensing point information, the classifying apparatus 2000 generates the monitoring data 50 from the waterfall data 10 (S212).

When it is determined in the step S204 that the sensing point information is stored (S204: YES), the classifying apparatus 2000 acquires the sensing point information from the storage device (S214), and generates the monitoring data 50 from the waterfall data 10 based on the sensing point information (S212).

It is noted that an expiration period may be set to the sensing point information in order to re-generate the sensing point information some time. In this case, the classifying apparatus 2000 also determines whether or not the sensing point information in the storage device is valid based on its expiration period. Then, only when the valid sensing point information is stored in the storage device, the classifying apparatus 2000 use that sensing point information to generate the monitoring data 50. Otherwise, the classifying apparatus 2000 performs the steps S206 to S210 to generate a new sensing point information.

### Output of Result

The classifying apparatus 2000 may be configured to output one or more pieces of information, generally called “output information”, that are related to the result of the classification of the sensing points. The output information may include the sensing point information, the monitoring data 50, or both.

It is noted that there are various ways to output the output information. In some implementations, the output information may be put into a storage device, displayed on a display device, or sent to another computer such as a PC or smart phone of the user of the classifying apparatus 2000.

### Example Embodiment 2

### Overview

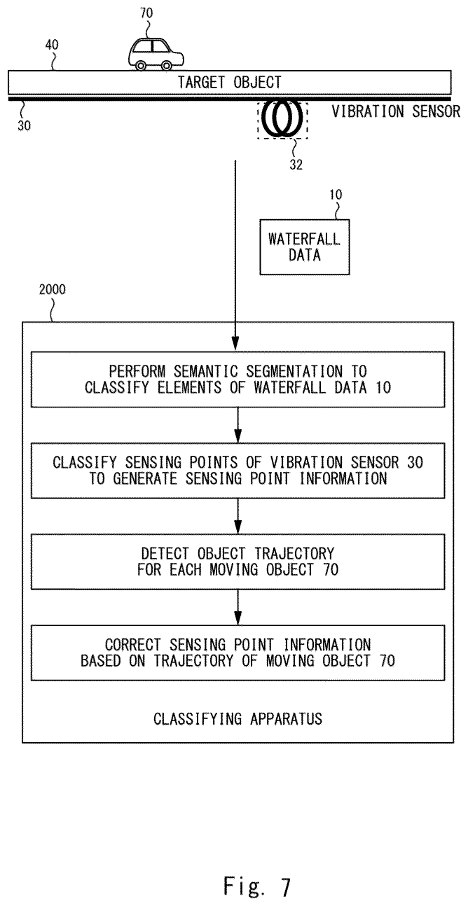

FIG. 7 illustrates an overview of the classifying apparatus 2000 of the second example embodiment. It is noted that the overview illustrated by FIG. 7 shows an example of operations of the classifying apparatus 2000 of the second example embodiment to make it easy to understand the classifying apparatus 2000 of the second example embodiment, and does not limit or narrow the scope of possible operations of the classifying apparatus 2000 of the second example embodiment.

In this example embodiment, it is assumed that there are one or more moving objects 70 on the target object 40 that cause the target object 40 to vibrate. For example, when the target object 40 is a road, the moving objects 70 may be vehicles (e.g., cars or mortar cycles) which run on the road. In addition, it is assumed that the waterfall data 10 is formed as a matrix data whose column represents sensing points whereas whose row represents points in time, or vice versa. Unless otherwise stated, the column of the waterfall data 10 represents sensing points whereas the row thereof represents points in time.

Under the assumption mentioned above, the classifying apparatus 2000 detects a trajectory (e.g., a time series of locations) for one or more moving objects 70 from the waterfall data 10, and uses the detected trajectory to modify the sensing point information (i.e., the result of the classification of the sensing points that is performed by the classifying unit 2060). In other words, some sensing points that are classified by the classifying unit 2060 as the monitoring point may be re-classified as the non-monitoring points, some sensing points that are classified by the classifying unit 2060 as the non-monitoring point may be re- classified as the monitoring points, or both. Hereinafter, a trajectory of the moving object 70 is called “object trajectory”.

It is considered that the closer a sensing point is to the location of the moving object 70, the larger the amplitude of the vibration that is sensed at that sensing point. Thus, the object trajectory can be detected based on the amplitude of the vibration indicated by the waterfall data 10.

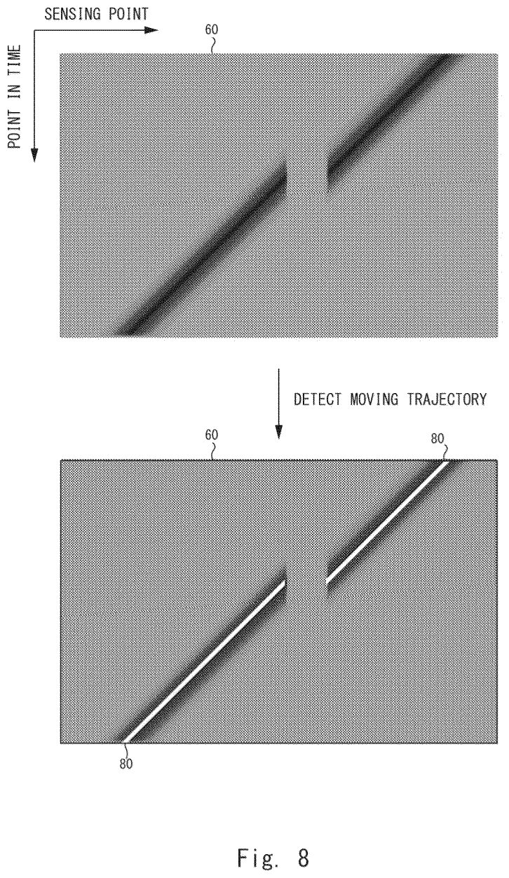

FIG. 8 illustrates the object trajectory detected from the waterfall data 10. In this example, the waterfall data 10 is formed as a waterfall image 60 whose X axis represents sensing points and whose Y axis represents points in time. The waterfall image 60 is illustrated as a grayscale image whose pixel has a larger value as the amplitude of the vibration corresponding to the pixel is larger. For the convenience of illustration, the darker color is depicted with denser and larger dots. The object trajectory 80 is depicted with white lines thar are superimposed on the waterfall image 60.

As illustrated by FIG. 8, the object trajectory 80 may be non-continuous (cut off, in other words) due to the existence of the non-monitoring points as illustrated by FIG. 8. If the sensing points are not correctly classified into the monitoring point and the non-monitoring point, the object trajectory 80 becomes non-continuous when the regions corresponding to the non-monitoring points are removed from the waterfall data 10.

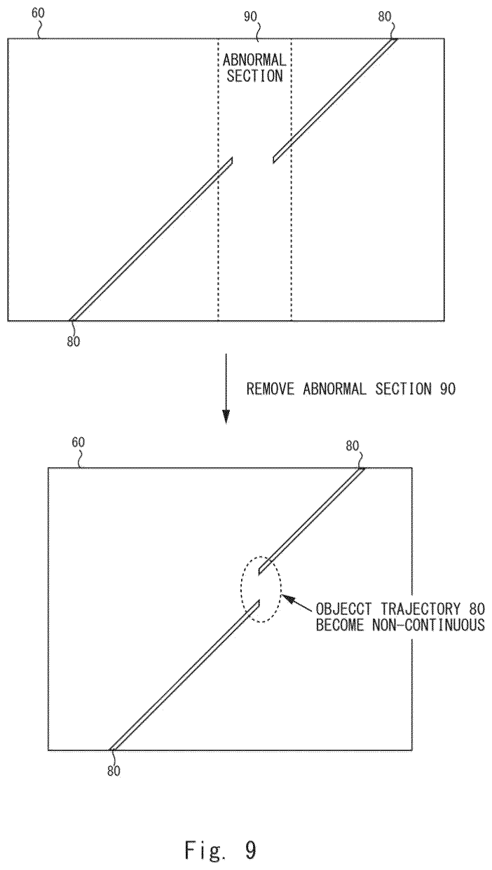

FIG. 9 illustrates the object trajectory 80 in a case where the sensing points are not correctly classified. The waterfall image 60 includes an abnormal section 90 that is a region of one or more continuous non-monitoring sections. In the case illustrated by FIG. 9, the object trajectory 80 becomes non-continuous when the classifying apparatus 2000 removes the abnormal section 90 from the waterfall image 60 to generate the monitoring data 50.

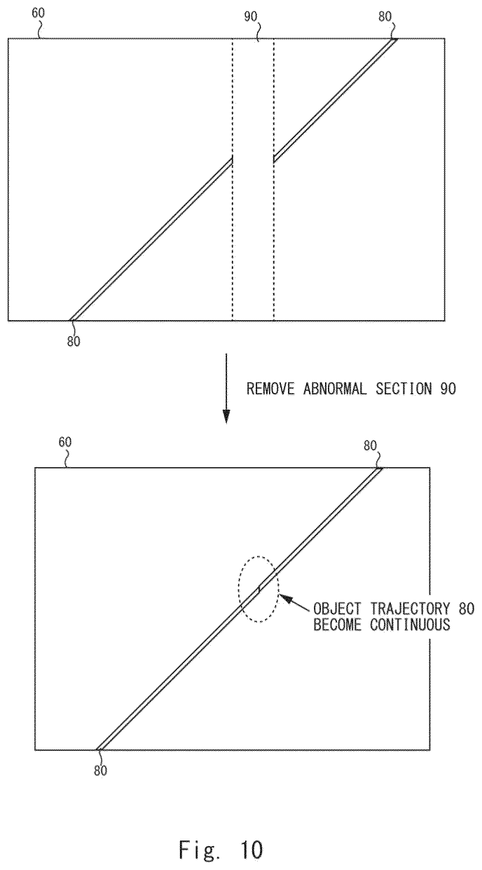

On the other hand, if the sensing points are correctly classified into the monitoring point and the non-monitoring point, the object trajectory 80 becomes continuous when the regions corresponding to the non-monitoring points are removed from the waterfall data 10. FIG. 10 illustrates the object trajectory 80 in a case where the sensing points are correctly classified. In the case illustrated by FIG. 10, the object trajectory 80 becomes continuous in the monitoring data 50 when the classifying apparatus 2000 removes the abnormal section 90 from the waterfall image 60 to generate the monitoring data 50.

Taking the fact mentioned above into consideration, the classifying apparatus 2000 of the second example embodiments corrects the sensing point information based on the object trajectory 80 detected from the waterfall data 10. Specifically, the start point, the end point, or both of the abnormal section 90 is corrected so as to make the object trajectory 80 almost continuous before and after the abnormal section 90 (in other words, so that the object trajectory 80 becomes almost continuous when the abnormal section 90 is removed from the waterfall data 10).

### Example of Advantageous Effect

According to the classifying apparatus 2000 of the second example embodiment, the sensing point information is corrected based on the object trajectory 80, which is the trajectory of the moving object 70 that moves on the target object 40. As a result, errors in the sensing point information due to misclassification can be reduce, thereby making the sensing point information more accurate.

Hereinafter, more detailed explanation of the classifying apparatus 2000 will be described.

### Example of Functional Configuration

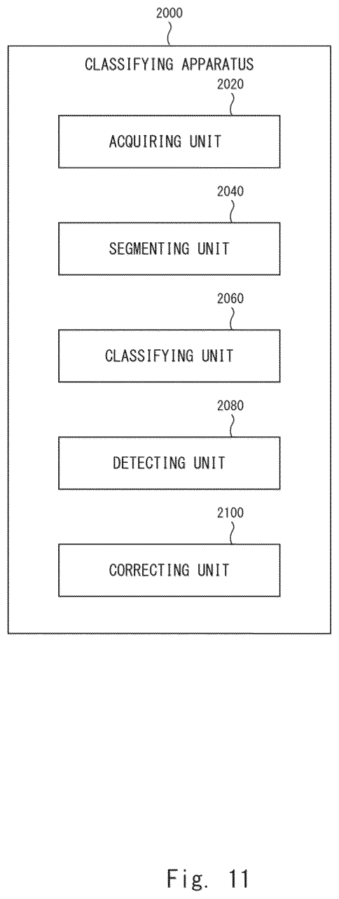

FIG. 11 is a block diagram illustrating an example of the functional configuration of the classifying apparatus 2000 of the second example embodiment. Same as the classifying apparatus 2000 of the first example embodiment, the classifying apparatus 2000 of the second example includes the acquiring unit 2020, the segmenting unit 2040, and the classifying unit 2060. In addition, the classifying apparatus 2000 of the second example embodiment further includes a detecting unit 2080 and a correcting unit 2100. The detecting unit 2080 detects one or more object trajectory 80 from the waterfall data 10. The correcting unit 2100 corrects the sensing point information based on the object trajectory 80.

### Example of Hardware Configuration

The classifying apparatus 2000 of the second example embodiment may be implemented in a similar manner to the manner by which the classifying apparatus 2000 of the first example embodiment is realized. For example, the classifying apparatus 2000 of the second example embodiment is realized by the computer 1000 that is illustrated by FIG. 3. However, the storage device 1080 of the second example embodiment includes the program that implements the functions of the classifying apparatus 2000 of the second example embodiment.

### Flow of Process

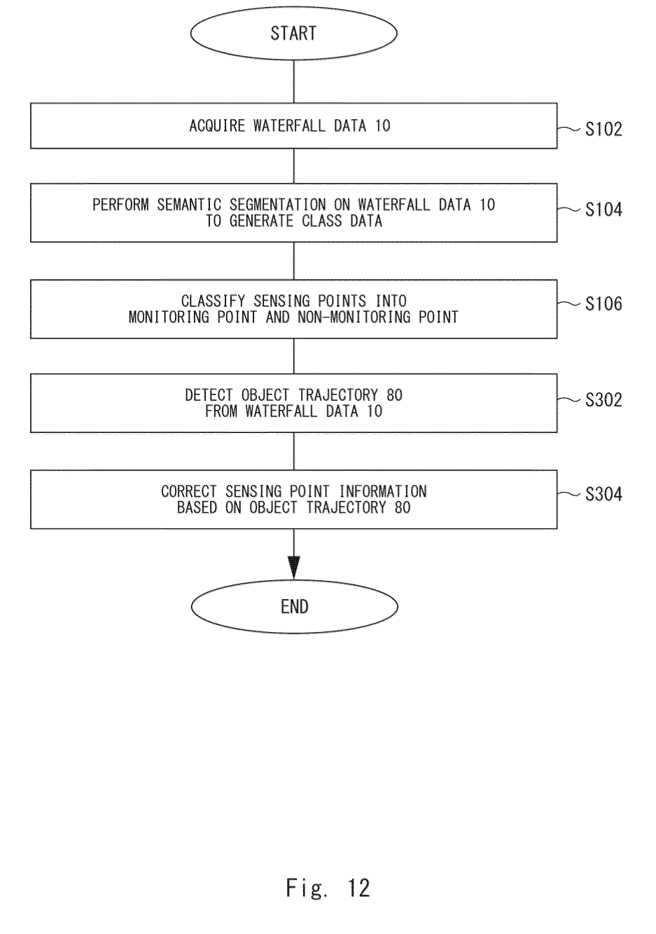

FIG. 12 is a flowchart illustrating an example flow of processes performed by the classifying apparatus 2000 of the second example embodiment. The classifying apparatus 2000 of the second example embodiment may perform the steps S102 to S106 in the same manner as that of the first example embodiment. After performing the step S106, the detecting unit 2080 detects the object trajectory 80 from the waterfall data 10 (S302), and corrects the sensing point information based on the object trajectory 80 (S304).

### Detection of Object Trajectory 80: S302

The detecting unit 2080 detects one or more object trajectories 80 from the waterfall data 10 (S302). There are well-known ways to detect a trajectory of a moving object 70 from a time series data that indicates the amplitude of vibration for two or more locations, and one of those ways can be applied to the detecting unit 2080. For example, the detecting unit 2080 may detect, for each sensing data 20 in the waterfall data 10, one or more locations (i.e., sensing points) each of which a moving object 70 is predicted to be located at. Specifically, there may be one or more maximum points in the sensing data 20, and the sensing points corresponding to the maximum points are predicted to be the locations of the moving objects 70. Then, the object trajectory 80 is detected by connecting the detected locations of the moving objects 70 over time.

### Correction of Sensing Point Information: S304

The correcting unit 2100 corrects the sensing point information that is generated by the classifying unit 2060 (S304). To do so, the classifying apparatus 2000 determines one or more abnormal sections 90 from the waterfall data 10 based on the sensing point information. Then, for each abnormal section 90, the correcting unit 2100 corrects the start point, the end point, or both of the abnormal section 90 so as to make the object trajectory 80 almost continuous during the abnormal section 90, thereby correcting the sensing point information.

When there is a single object trajectory 80 that crosses an abnormal section 90, the correcting unit 2100 may determine a target width Wt based on the object trajectory 80, and change the width of the abnormal section 90 into Wt, thereby correcting the sensing point information. Changing the width of the abnormal section 90 includes re-classifying the sensing points around the borders of the abnormal section 90.

Suppose that the start point and the end point of the abnormal section 90 are the sensing points Ss and Se, respectively. In addition, the target width Wt of the abnormal section 90 is six smaller than the current width of thereof. In this case, the correcting unit 2100 may shift the start point and the end point by +3 and −3, respectively. To do so, the sensing point Ss, Ss+1, Se+2, Se, Se−1, and Se−2 are re-classified into the monitoring point.

The target width Wt of the abnormal section can be determined, but not limited to, by finding the end points of the object trajectory 80 using techniques such as line detection, kink detection or vehicle tracking algorithms. The width Wt denotes the length, or distance, of the non-monitoring section. Wt, when estimated correctly, makes the object trajectory continuous as shown in FIG. 10 after removing this abnormal section. If the object trajectory is not continuous, the width Wt is estimated again by correcting the end point coordinates of the vehicle trajectories.

When there are two or more object trajectories 80 that cross the same abnormal section 90 as each other, the correcting unit 2100 may determine the target width Wt of the abnormal section 90 based on the object trajectories 80 that cross the abnormal section 90, and may shift the start point and the end point of the abnormal section 90 by the same distance as each other so as to change the width of the abnormal section 90 into Wt. Specifically, for each object trajectory 80 crossing the same abnormal section 90 as each other, the correcting unit 2100 determines a candidate width Wc of the abnormal section 90, and computes a statistical value (e.g., an average value) of the candidate widths Wc as Wt. The candidate width Wc corresponding to an object trajectory OT1 may be determined in the same way as the way to determine the target width Wt in the case where there is no object trajectory 80 other than OT1 that crosses the abnormal section 90, which is explained above.

When determining the target width Wt of the abnormal section 90, the correcting unit 2100 may exclude one or more outliers (called “outlier trajectory”) from the object trajectories 80 for which the candidate width Wc are computed. Suppose that there are four object trajectories OT1, OT2, OT3, and OT4 that cross the abnormal section A1. In addition, the object trajectory OT2 is determined to be an outliner trajectory. In this case, the correcting unit 2100 computes the candidate width Wc1, Wc3, and Wc4 for OT1, OT3, and OT4, respectively. Since OT2 is determined to be an outlier, the candidate width Wc is not computed for OT2. Then, the correcting unit 2100 computes a statistical value SV1 of Wc1, Wc2, and Wc3 as the target width Wt of the abnormal section A1, and modifies the start point and the end point of A1 included in the sensing point information so that the width of A1 is changed into Wt(=SV1).

To determine whether or not the object trajectory 80 is an outlier trajectory, the correcting unit 2100 may compute a degree of irregularity of the object trajectory 80. The correcting unit 2100 determines whether or not the degree of irregularity of the object trajectory 80 is less than a predefined threshold. When it is determined that the degree of irregularity of the object trajectory 80 is less than the predefined threshold, the correcting unit 2100 computes the candidate width of the abnormal section based on that object trajectory 80. On the other hand, when it is determined that the degree of irregularity of the object trajectory 80 is not less than the predefined threshold, the correcting unit 2100 does not compute the candidate width of the abnormal section based on that object trajectory 80.

In some embodiments, a degree of linearity (proportionality, in other words) of the object trajectory 80 can be used to represent the degree of irregularity of the object trajectory 80. Specifically, the degree of irregularity of the object trajectory 80 is determined to be higher as the degree of linearity of the object trajectory 80 is lower. There are well-known ways to measure a degree of linearity of a curve, and one of those ways can be applied to the correcting unit 2100 to compute the degree of linearity of the object trajectory 80.

In other embodiments, the degree of irregularity may be measured based on direction, change in speed, overall travel behavior, or two or more thereof that are computed using the object trajectory 80. Specifically by tracking the object trajectory for measures as mentioned before for travelling behaviors such as low speeds, over-speeding or sudden change in speeds. The irregular trajectories show measure of these behaviors as outliers compared to the neighboring vehicle trajectories in this measuring section.

### Usage of Result

In some embodiments, the classifying apparatus 2000 uses the corrected sensing point information to generate the monitoring data 50 from the waterfall data 10. Then, the monitoring data 50 and the object trajectories 80 detected from the waterfall data 10 can be used in a traffic flow monitoring application. The traffic flow monitoring application may compute traffic flow properties, such as vehicle speeds and vehicle count. These properties can be used to monitor traffic flow.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### SUPPLEMENTARY NOTES

### Supplementary Note 1

A classifying apparatus comprising:
at least one memory that is configured to store instructions; and
at least one processor that is configured to execute the instructions to:
acquire a waterfall data that indicates amplitude of vibration for each point in time and for each sensing point in a vibration sensor that is placed along a target object;
perform semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classify the sensing points into the monitoring point and the non-monitoring point based on the class data.

### Supplementary Note 2

The classifying apparatus according to supplementary note 1,
wherein the classifying the sensing points includes performing, for each sensing point:
   computing the number of the elements of the waterfall data that correspond to the sensing point and to which the normal class are assigned;
   determining whether the sensing point is the monitoring point or the non-monitoring point based on the computed number.

### Supplementary Note 3

The classifying apparatus according to supplementary note 1 or 2,
wherein the at least one processor is further configured to:
   generate sensing point information that indicates, for each sensing point, whether the sensing point is the monitoring point or the non-monitoring point;
   detect one or more trajectories of moving objects from the waterfall data, the moving object being an object that moves on the target object; and correct the sensing point information based on the detected trajectories.

### Supplementary Note 4

The classifying apparatus according to supplementary note 3,
wherein the correcting the sensing point information includes performing, for each one of abnormal sections that are regions of one or more consecutive non- monitoring points in the waterfall data:
   for each one of trajectories that cross the abnormal section, determining a candidate width of the abnormal section based on the trajectory;
   computing a statistical value of the computed candidate widths as a target width of the abnormal section; and
   modifying a width of the abnormal section into the target width.

### Supplementary Note 5

The classifying apparatus according to supplementary note 4,
wherein determining the candidate width of the abnormal section for the trajectory including:
   computing a degree of irregularity of the trajectory; and
   computing the candidate width of the abnormal section based on the trajectory when the degree of irregularity of the trajectory is less than a predefined threshold.

### Supplementary Note 6

The classifying apparatus according to supplementary note 5,
wherein the degree of irregularity of the trajectory is determined based on a degree of linearity of the trajectory.

### Supplementary Note 7

A classifying method that is computed by a computer, comprising:
acquiring a waterfall data that indicates amplitude of vibration for each point in time and for each sensing point in a vibration sensor that is placed along a target object;
performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classifying the sensing points into the monitoring point and the non- monitoring point based on the class data.

### Supplementary Note 8

The classifying method according to supplementary note 7,
wherein the classifying the sensing points includes performing, for each sensing point:
   computing the number of the elements of the waterfall data that correspond to the sensing point and to which the normal class are assigned;
   determining whether the sensing point is the monitoring point or the non-monitoring point based on the computed number.

### Supplementary Note 9

The classifying method according to supplementary note 7 or 8, further comprising:
generating sensing point information that indicates, for each sensing point, whether the sensing point is the monitoring point or the non-monitoring point;
detecting one or more trajectories of moving objects from the waterfall data, the moving object being an object that moves on the target object; and
correcting the sensing point information based on the detected trajectories.

### Supplementary Note 10

The classifying method according to supplementary note 9,
wherein the correcting the sensing point information includes performing, for each one of abnormal sections that are regions of one or more consecutive non-monitoring points in the waterfall data:
   for each one of trajectories that cross the abnormal section, determining a candidate width of the abnormal section based on the trajectory;
   computing a statistical value of the computed candidate widths as a target width of the abnormal section; and
   modifying a width of the abnormal section into the target width.

### Supplementary Note 11

The classifying method according to supplementary note 10,
wherein determining the candidate width of the abnormal section for the trajectory including:
   computing a degree of irregularity of the trajectory; and
   computing the candidate width of the abnormal section based on the trajectory when the degree of irregularity of the trajectory is less than a predefined threshold.

### Supplementary Note 12

The classifying method according to supplementary note 11,
wherein the degree of irregularity of the trajectory is determined based on a degree of linearity of the trajectory.

### Supplementary Note 13

A non-transitory computer-readable storage medium storing a program that causes a computer to execute:
acquiring a waterfall data that indicates amplitude of vibration for each point in time and for each sensing point in a vibration sensor that is placed along a target object;
performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classifying the sensing points into the monitoring point and the non-monitoring point based on the class data.

### Supplementary Note 14

The storage medium according to supplementary note 13,
wherein the classifying the sensing points includes performing, for each sensing point:
   computing the number of the elements of the waterfall data that correspond to the sensing point and to which the normal class are assigned;
   determining whether the sensing point is the monitoring point or the non-monitoring point based on the computed number.

### Supplementary Note 15

The storage medium according to supplementary note 13 or 14,
wherein the program causes the computer to further execute:
   generating sensing point information that indicates, for each sensing point, whether the sensing point is the monitoring point or the non-monitoring point;
   detecting one or more trajectories of moving objects from the waterfall data, the moving object being an object that moves on the target object; and
   correcting the sensing point information based on the detected trajectories.

### Supplementary Note 16

The storage medium according to supplementary note 15,
wherein the correcting the sensing point information includes performing, for each one of abnormal sections that are regions of one or more consecutive non-monitoring points in the waterfall data:
   for each one of trajectories that cross the abnormal section, determining a candidate width of the abnormal section based on the trajectory;
   computing a statistical value of the computed candidate widths as a target width of the abnormal section; and
   modifying a width of the abnormal section into the target width.

### Supplementary Note 17

The storage medium according to supplementary note 16,
wherein determining the candidate width of the abnormal section for the trajectory including:
   computing a degree of irregularity of the trajectory; and
   computing the candidate width of the abnormal section based on the trajectory when the degree of irregularity of the trajectory is less than a predefined threshold.

### Supplementary Note 18

The storage medium according to supplementary note 17,
wherein the degree of irregularity of the trajectory is determined based on a degree of linearity of the trajectory.

### REFERENCE SIGNS LIST

10 waterfall data
20 sensing data
30 vibration sensor
40 target object
50 monitoring data
60 waterfall image
70 moving object
80 object trajectory
90 abnormal section
1000 computer
1020 bus
1040 processor
1060 memory
1080 storage device
1100 input/output interface
1120 network interface
2000 classifying apparatus
2020 acquiring unit
2040 segmenting
2060 classifying unit
2080 detecting unit
2100 correcting unit

What is claimed is:

1. A classifying apparatus comprising:
at least one memory that is configured to store instructions; and
at least one processor that is configured to execute the instructions to:
acquire a waterfall data that indicates amplitude of vibration for each point in time and for each sensing point in a vibration sensor that is placed along a target object;
perform semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classify the sensing points into the monitoring point and the non-monitoring point based on the class data.

2. The classifying apparatus according to claim 1,
wherein the classifying the sensing points includes performing, for each sensing point:
computing the number of the elements of the waterfall data that correspond to the sensing point and to which the normal class are assigned;
determining whether the sensing point is the monitoring point or the non-monitoring point based on the computed number.

3. The classifying apparatus according to claim 1,
wherein the at least one processor is further configured to:
generate sensing point information that indicates, for each sensing point, whether the sensing point is the monitoring point or the non-monitoring point;
detect one or more trajectories of moving objects from the waterfall data, the moving object being an object that moves on the target object; and
correct the sensing point information based on the detected trajectories.

4. The classifying apparatus according to claim 3,
wherein the correcting the sensing point information includes performing, for each one of abnormal sections that are regions of one or more consecutive non-monitoring points in the waterfall data:
for each one of trajectories that cross the abnormal section, determining a candidate width of the abnormal section based on the trajectory;
computing a statistical value of the computed candidate widths as a target width of the abnormal section; and
modifying a width of the abnormal section into the target width.

5. The classifying apparatus according to claim 4,
wherein determining the candidate width of the abnormal section for the trajectory including:
computing a degree of irregularity of the trajectory; and
computing the candidate width of the abnormal section based on the trajectory when the degree of irregularity of the trajectory is less than a predefined threshold.

6. The classifying apparatus according to claim 5,
wherein the degree of irregularity of the trajectory is determined based on a degree of linearity of the trajectory.

7. A classifying method that is computed by a computer, comprising:
acquiring a waterfall data that indicates amplitude of vibration for each point in time and for each sensing point in a vibration sensor that is placed along a target object;
performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classifying the sensing points into the monitoring point and the non-monitoring point based on the class data.

8. The classifying method according to claim 7,
wherein the classifying the sensing points includes performing, for each sensing point:
computing the number of the elements of the waterfall data that correspond to the sensing point and to which the normal class are assigned;
determining whether the sensing point is the monitoring point or the non-monitoring point based on the computed number.

9. The classifying method according to claim 7, further comprising:
generating sensing point information that indicates, for each sensing point, whether the sensing point is the monitoring point or the non-monitoring point;
detecting one or more trajectories of moving objects from the waterfall data, the moving object being an object that moves on the target object; and
correcting the sensing point information based on the detected trajectories.

10. The classifying method according to claim 9,
wherein the correcting the sensing point information includes performing, for each one of abnormal sections that are regions of one or more consecutive non-monitoring points in the waterfall data:
for each one of trajectories that cross the abnormal section, determining a candidate width of the abnormal section based on the trajectory;
computing a statistical value of the computed candidate widths as a target width of the abnormal section; and
modifying a width of the abnormal section into the target width.

11. The classifying method according to claim 10,
wherein determining the candidate width of the abnormal section for the trajectory including:
computing a degree of irregularity of the trajectory; and
computing the candidate width of the abnormal section based on the trajectory when the degree of irregularity of the trajectory is less than a predefined threshold.

12. The classifying method according to claim 11,
wherein the degree of irregularity of the trajectory is determined based on a degree of linearity of the trajectory.

13. A non-transitory computer-readable storage medium storing a program that causes a computer to execute:
acquiring a waterfall data that indicates amplitude of vibration for each point in time and for each sensing point in a vibration sensor that is placed along a target object;
performing semantic segmentation on the waterfall data to generate a class data that indicates a normal class or an abnormal class for each element of the waterfall data, the normal class being assigned to the element whose sensing point is predicted to be a monitoring point, the abnormal class being assigned to the element whose sensing point is predicted to be a non-monitoring point, the monitoring point being the sensing point that is placed along the target object, the non-monitoring point being the sensing point that is not placed along the target object; and
classifying the sensing points into the monitoring point and the non-monitoring point based on the class data.

14. The storage medium according to claim 13,
wherein the classifying the sensing points includes performing, for each sensing point:
computing the number of the elements of the waterfall data that correspond to the sensing point and to which the normal class are assigned;
determining whether the sensing point is the monitoring point or the non-monitoring point based on the computed number.

15. The storage medium according to claim 13,
wherein the program causes the computer to further execute:
generating sensing point information that indicates, for each sensing point, whether the sensing point is the monitoring point or the non-monitoring point;
detecting one or more trajectories of moving objects from the waterfall data, the moving object being an object that moves on the target object; and
correcting the sensing point information based on the detected trajectories.

16. The storage medium according to claim 15,
wherein the correcting the sensing point information includes performing, for each one of abnormal sections that are regions of one or more consecutive non-monitoring points in the waterfall data:
for each one of trajectories that cross the abnormal section, determining a candidate width of the abnormal section based on the trajectory;
computing a statistical value of the computed candidate widths as a target width of the abnormal section; and
modifying a width of the abnormal section into the target width.

17. The storage medium according to claim 16,
wherein determining the candidate width of the abnormal section for the trajectory including:
computing a degree of irregularity of the trajectory; and
computing the candidate width of the abnormal section based on the trajectory when the degree of irregularity of the trajectory is less than a predefined threshold.

18. The storage medium according to claim 17,
wherein the degree of irregularity of the trajectory is determined based on a degree of linearity of the trajectory.
